(19) United States
(12) Patent Application Publication
(10) Pub. No.: US 2012/0043280 A1
(43) Pub. Date: Feb. 23, 2012

(54) IONIC REMOVAL PROCESS USING FILTER MODIFICATION BY SELECTIVE INORGANIC ION EXCHANGER EMBEDMENT

(75) Inventors: Heping Wang, Rolla, MO (US); Robert Parker, Rolla, MO (US); Joseph D. Graber, Rolla, MO (US); Dan W. Hawley, St. James, MO (US); Ryan L. Buschjost, Rolla, MO (US); Trisha May, Rolla, MO (US)

(73) Assignee: BREWER SCIENCE INC., Rolla, MO (US)

(21) Appl. No.: 12/860,473

(22) Filed: Aug. 20, 2010

(51) Int. Cl. B01D 15/00; B05D 3/00; B05D 3/04; B01D 15/02

(52) U.S. Cl. 210/679; 210/502.1; 210/335; 427/331; 427/348

(57) ABSTRACT

New methods of removing impurities from solvent-based compositions using inorganic particle-embedded filters and an ion exchange process are provided. The methods comprise passing a composition through a filter embedded with inorganic particles to yield a filtered composition. Filters comprising filtration media embedded with inorganic particles and methods of producing the same are also provided.

### BACKGROUND OF THE INVENTION

1. Field of the Invention

The present invention is concerned with removal of ionic impurities from solvent-based compositions using inorganic particle-embedded filters and methods of forming the same.

2. Description of Related Art

Ionic impurities in semiconductor manufacturing materials have proved to be a source of device defects. As the semiconductor industry continues to drive device generations toward the 32-nm node, and even further down to the sub-32 nm node, the impact of ionic impurities in processing materials such as photoresists and bottom anti-reflective coatings becomes increasingly significant in terms of device performance and reliability. One of the main challenges in materials manufacturing is effectively purifying the compositions to achieve ionic species concentration levels of parts per billion.

Many different approaches have been employed for filtering materials used for microelectronics manufacturing. The requisite pore size of filter media has steadily decreased as feature sizes on chips have gotten smaller. Currently, the microelectronics industry utilizes either of two approaches, or a combination of the two, to filter ions from materials to achieve ionic impurity concentrations of about 50 ppb. The first approach involves using synthetic filter media with pore sizes of about 0.4 μm or less. The other approach involves using ion exchange columns. Additional work, other than simply reducing filter pore sizes, has been done to attempt to improve the effectiveness of filter media in general, such as by impregnating filter media in order to obtain better performance from the filters.

### SUMMARY OF THE INVENTION

The invention is generally directed towards a method of removing ionic impurities from a solvent-based composition. The method comprises passing the composition through an embedded filter to yield a filtered composition. Advantageously, the filter comprises filtration media embedded with inorganic particles.

The invention also provides an embedded filter for removing impurities from solvent-based compositions. The filter comprises a filtration media embedded with inorganic particles. The particles have an average particle size of from about 0.02 μm to about 50 μm.

The invention is also directed towards a method of preparing an inorganic particle-embedded filter. The method comprises providing a slurry comprising inorganic particles dispersed in a solvent system, passing the slurry through a filtration media, and rinsing the filtration media with additional solvent to remove loose (unembedded) inorganic particles to thereby yield the embedded filter.

### BRIEF DESCRIPTION OF THE DRAWINGS

FIG. 1 is a schematic drawing of a filter system according to the invention;

FIG. 2 is a schematic view of the filter embedding assembly used in the filter system of FIG. 1;

FIG. 3 is a schematic illustration of a pleated membrane for use in the invention;

FIGS. 4(A) and (B) are photographs of: (A) the inside of an embedded pleated membrane prepared using the same procedures as in Example 2; and (B) the outside of the membrane;

FIG. 5 is a graph showing the portion of inorganic particles retained by the filtration media during integral portion embedment;

FIG. 6 is a graph showing the portion of inorganic particle retained by the filtration media during differential portion embedment;

FIG. 7 is a graph showing the ion concentration results from Example 1 for various impurities;

FIG. 8 is a graph demonstrating the effect of the inventive ionic removal process in removing on-wafer defects, according to Example 4;

FIG. 9 is a graph of the on-wafer defect results from Example 5; and

FIG. 10 is a graph showing the effectiveness of traditional anion exchange resin at removing any process contaminants that may occur during the ionic removal process of the invention according to Example 6.

### DETAILED DESCRIPTION

In more detail, the present invention is directed towards methods of removing impurities and contaminants from various compositions using inorganic particles, and filter systems for achieving the same. In more detail, the invention is concerned with an embedded filter comprising filtration media embedded with inorganic particles. The filtration media preferably comprises a porous matrix or membrane. As used herein, the term “embedded” means that the inorganic particles are fixed or incorporated into the surrounding porous matrix of the filtration media, such that the filtration media becomes impregnated with such particles, while retaining the ability to filter solvent-based compositions therethrough, so that composition passing through the filtration media is brought into contact with the inorganic particles to remove impurities from the composition via an ion exchange process. More specifically, the inorganic particles are physically immobilized (rather than chemically bonded) on the porous matrix. The inorganic particles are preferably distributed substantially uniformly throughout the matrix. The embedded particles preferably consist essentially (or even consist) of the inorganic particles.

Suitable inorganic particles for use in the embedded filter include metal oxides, metal salts, and combinations thereof. Preferred metal oxides and metal salts include transition metals, and metalloids. Particularly preferred metal oxides and metal salts are those of antimony, tungsten, or molybdenum, and combinations thereof. Suitable metal oxides include mono-, di-, tri, tetra-, and pentoxides thereof. The inorganic particles preferably have an average particle size of from about 0.02 μm to about 50 μm, more preferably from about 0.02 μm to about 5 μm, and even more preferably from about 0.1 μm to about 1 μm. The “average particle size,” as used herein, is defined as the average maximum surface-to-surface dimension of the particles (e.g., this would be the diameter in the case of spherical particles) The inorganic particles can comprise discrete particles having the above dimensions, or, they can comprise colloidal particles or agglomerates of smaller (nano-sized particles), wherein the individual agglomerates have the above dimensions. It will be appreciated that the size of the inorganic particles can be selected depending upon the average pore size of the filter to be embedded. However, it is preferred that average particle size of the particles be at least about 0.1 μm.

The filtration media is preferably substantially free of other particulate filter aids including diatomaceous earth, magnesia, perlite, talc, colloidal silica, polymeric particulates, activated carbon, molecular sieves, or clay. The filtration media is also preferably substantially free of: organic particles; non-membrane polymeric materials; cation exchange resins (such as sulfonated phenol-formaldehyde condensates, sulfonated phenol-benzaldehyde condensates, sulfonated styrene-divinyl benzene copolymers, sulfonated methacrylic acid-divinyl benzene copolymers, and other types of sulfonic or carboxylic acid group-containing polymers); anion exchange resins (such as resins having quaternary ammonium hydroxide exchange groups chemically bound thereto, including styrene-divinyl benzene copolymers substituted with tetramethylammoniumhydroxide and crosslinked polystyrene substituted with quaternary ammonium hydroxide); and chelating exchange resins (such as polyamines on polystyrene, polyacrylic acid and polyethyleneimine backbones, thiourea on polystryrene backbones, guanidine on polystryrene backbones, dithiocarbamate on polyethyleneimine backbones, hydroxamic acid on polyacrylate backbones, mercapto on polystyrene backbones, and cyclic polyamines on polyaddition and polycondensation resins).

To prepare the embedded filter, the inorganic particles are dispersed in a solvent system to form a slurry. Suitable solvent systems will comprise an organic solvent selected from the group consisting of propylene glycol monomethyl ether (PGME), propylene glycol methyl ether acetate (PGMEA), alcohols, aqueous mixtures (water), ethers, lactones, cyclohexanone, and mixtures thereof. The slurry preferably comprises from about 2% to about 30% by weight inorganic particles, more preferably from about 15% to about 25% inorganic particles, and even more preferably from about 20% to about 25% inorganic particles, based upon the total weight of the slurry taken as 100% by weight. More preferably, the slurry consists essentially (or even consists) of the inorganic particles and the solvent system. The slurry is then passed through the filtration media of the desired filter to embed the inorganic particles therein. Additional solvent is then used to wash or rinse the filter to remove any loose (unembedded) particles.

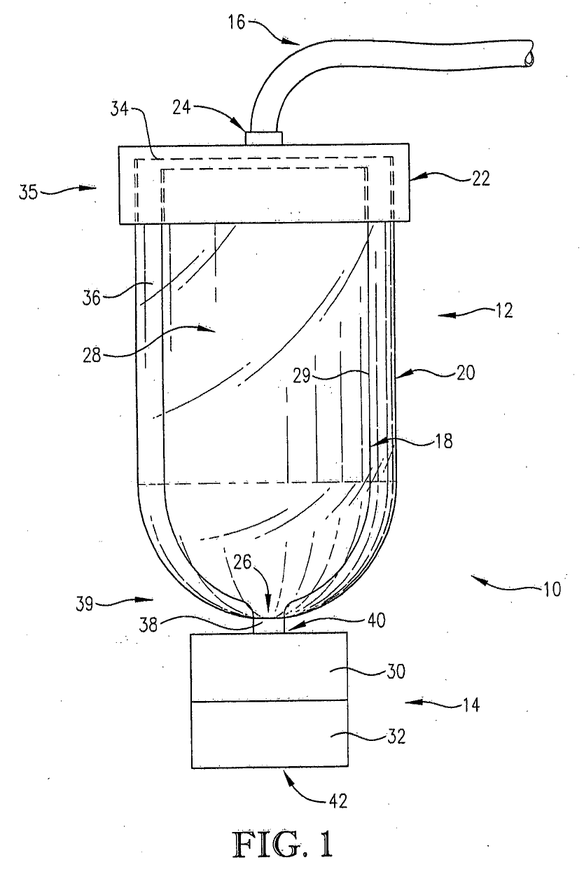

Referring to FIG. 1, a preferred filter system 10 according to the invention is schematically illustrated. The filter system 10 can be used to prepare an embedded filter according to the invention. The filter system 10 includes a filter embedding assembly 12, a filter stack 14, and an external pressure source 16.

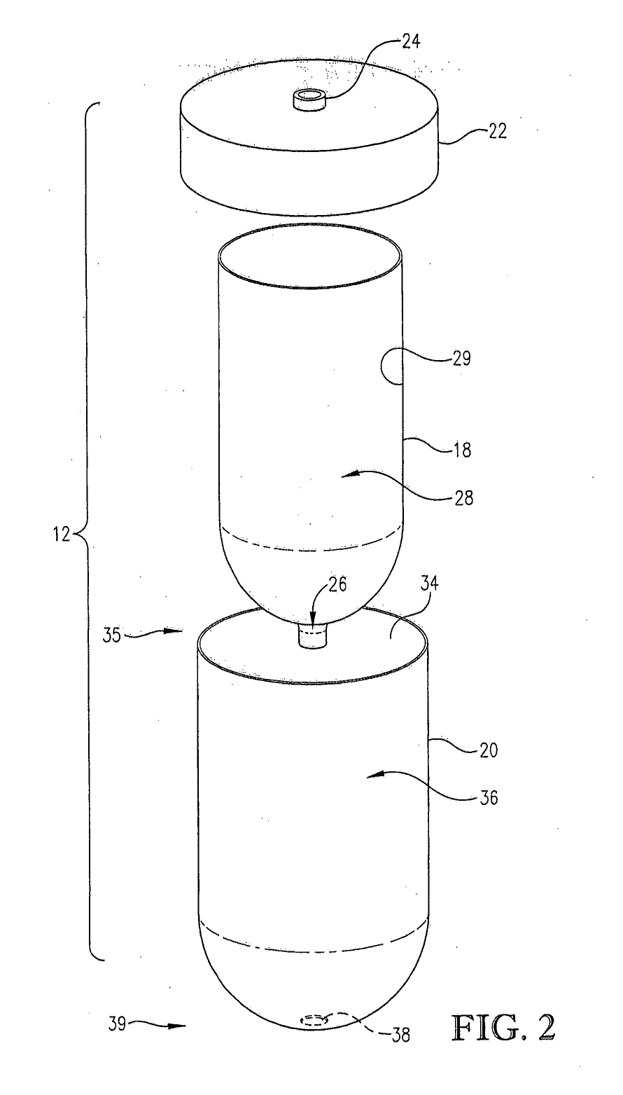

Filter embedding assembly 12 preferably includes a fluid cartridge 18, a cartridge retainer or housing 20 configured to receive the cartridge 18, and a retainer cap 22 having an inlet 24, as shown in FIG. 2. The cartridge 18 comprises an outlet 26 and a fluid-receiving space 28 defined by an interior sidewall 29 for containing a composition to be passed through the filter stack 14 via the outlet 26. The retainer 20 comprises an opening 34 at the proximal end 35 of the retainer 20, and an interior space 36 for receiving the cartridge 18. An additional opening 38 is at the distal end 39 of the retainer for receiving the cartridge outlet 26. Suitable filter embedding assemblies include any commercially-available fluid dispensing systems, such as Nordson EFD® Optimum® fluid dispensing components.

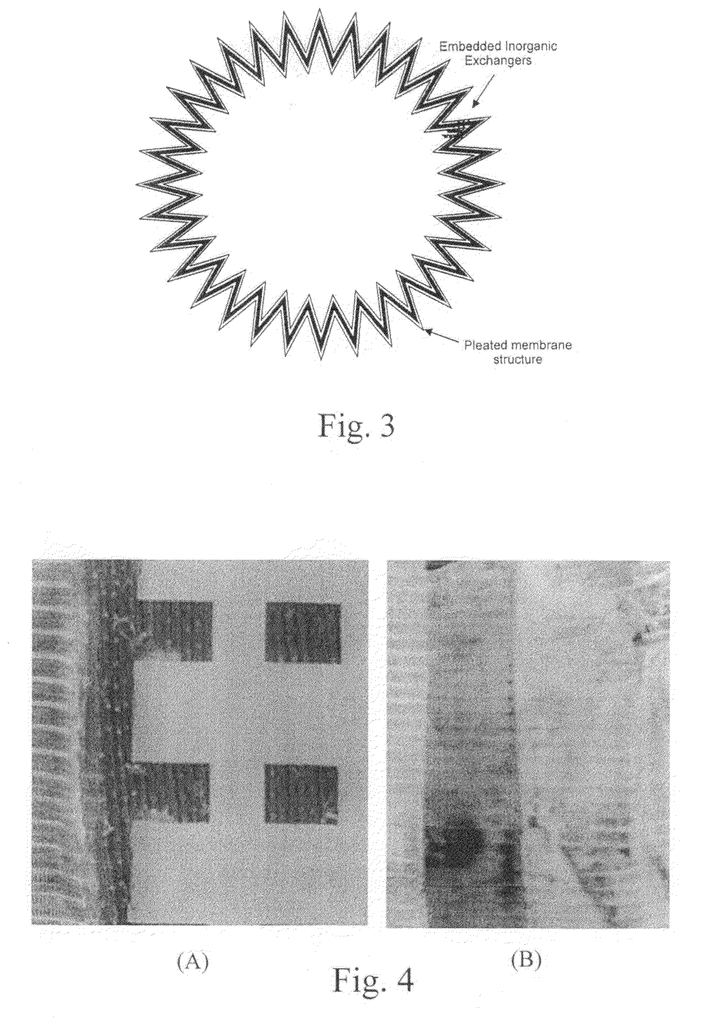

Referring back to FIG. 1, the filter stack 14 comprises an optional first filter 30 comprising a first filtration media and a second filter 32 comprising a second filtration media. When present, the first filtration media preferably comprises a porous matrix or membrane having an average pore size ranging from about 1 μm to about 10 μm, and more preferably from about 1.2 μm to about 5 μm. Suitable materials for use as the first filtration media are selected from the group consisting of fibers and microfibers of polypropylene, polyethylene, polytetrafluoroethylene (PTFE), nylon, and combinations thereof. Commercially-available filters such as those available from Meissner (Vangard® capsule filters) are particularly suitable for use in the invention. The second filtration media preferably comprises a porous matrix or membrane having an average pore size ranging from about 0.02 μm to about 1 μm, and more preferably from about 0.1 μm to about 0.2 μm. When a first filter 30 is used in the filter stack 14, the second filter 32 preferably has an average pore size that is from about 2% to about 4% of the average pore size of the first filter 30. Thus, the first filter is preferably a “coarse” filter, while the second filter is preferably a “fine” filter. Suitable materials for use as the second filtration media are selected from the group consisting of fibers and microfibers of high-density polypropylene (HDPE), ultra-high molecular weight polypropylene (UPE), PTFE, nylon, and combinations thereof. Particularly preferred second filters will comprise a pleated membrane construction, as shown in FIG. 3. A photograph of a disassembled pleated membrane embedded with inorganic particles according to the same procedures used in Example 2 is shown in FIG. 4, Commercially-available filters such as those available from Entregris (Optimizer® D PR) and Sartorius (Sartofluor® capsule filters) are particularly suitable for use in the invention. It will be appreciated that the make-up of the second filter 32 itself is not as important, so long as the inorganic particles can be embedded therein. That is, the second filter 32 primarily serves as scaffolding to facilitate contact between the composition being filtered and the inorganic particles.

Referring back to FIGS. 1 and 2, to assemble the filter system 10, the cartridge 18 is inserted through an opening 34 at the proximal end 35 of the retainer 20, and is received into an interior space 36 thereof, wherein the cartridge outlet 26 passes through an opening 38 at the distal end 39 of the retainer 20. Preferably, the interior space 36 of the retainer 20 has a shape that is complementary to the shape of the cartridge 18, so that the cartridge 18 fits closely within the retainer 20 to thereby facilitate containment of the cartridge 18 therein. The cap 22 is fitted over the opening 34 of the retainer 20 and secures the cartridge 18 within the interior space 36 of the retainer 20 during dispensing of the composition (not shown). The outlet 26 of the cartridge 18 is then coupled to the inlet side 40 of the filter stack 14, as shown in FIG. 1.

To embed the inorganic particles, a slurry is prepared by dispersing the inorganic particles to be embedded in the solvent system, as described above. This slurry is then added to the fluid-receiving space 28 of the cartridge 18. The cap 22 is secured to retain the cartridge 18 in the retainer 20. The cartridge 18 receives, through the cap inlet 24, pressurized air or gas from the external pressure source 16, which pushes or forces the slurry (not shown) from the cartridge 18, out the outlet 26 and through the filter stack 14. The outlet side 42 of the filter stack 14 can be connected to a collection container (not shown). The pressure preferably ranges between about 5 psi and about 20 psi, and more preferably between about 10 psi and about 12 psi. The pressurized air or gas can be delivered from the external pressure source 16 via a hose, tube, pipe, or other similar connector. Suitable gases to use with the filter system 10 include nitrogen, helium, argon, and/or oxygen. Pressurized ambient air can be also be used.

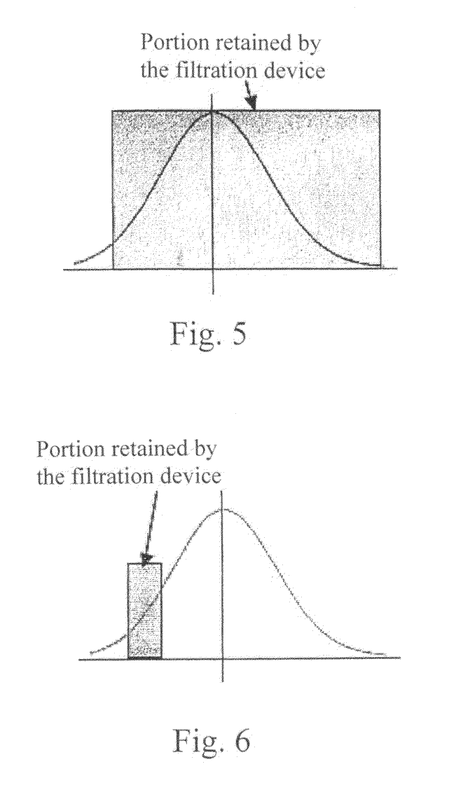

Regardless of the embodiment, embedment is preferably carried out using either integral portion embedment or differential portion embedment. For integral portion embedment, the slurry is filtered only through second filter 32 (i.e., the first filter 30 is absent from the filter stack 14). Particles that are larger than the pore size of the second filtration media are retained by the second filtration media and become embedded therein. Any inorganic particles that are smaller than the pore size of the second filtration media are passed through the second filter 32 and discarded. The portion retained by the filter stack 14 in this embodiment is depicted in FIG. 5.

For differential portion embedment, the slurry is filtered through the first filter 30 and the second filter 32 in series, where the pore size of the first filter 30 is greater than the pore size of the second filter 32. Any particles that are larger than the pore size of the first filtration media are retained therein, and particles that are smaller than the pore size of the first filtration media pass through the first filter 30 to the second filter 32 as filtrate. When the filtrate passes through the second filter 32, any particles that are larger than the pore size of the second filtration media are retained by the second filtration media and become embedded therein, and any particles that are smaller than the pore size of the second filtration media are passed through and discarded. The portion retained by the filter stack 14 in this embodiment is depicted in FIG. 6.

In either embodiment, the second filter 32 is then rinsed to remove any loose particles. If present, the first filter 30 is first removed from the filter stack 14, and the second filter 32 is coupled to the cartridge 18 outlet 26. Next, the fluid-receiving space 28 in the cartridge 18 is filled with additional organic solvent and the cap 22 is secured. Pressurized air or gas from the external source 16 is then introduced into the cap inlet 24 to force the solvent towards the outlet 26 and through the second filter 32 to flush out any loose particles. This process is preferably repeated at least one more time, and preferably at least two more times (for a total of about three rinsings).

Various other fluid handling systems can be used to prepare the embedded filter, For example, the slurry could be added to a hand-operated syringe coupled to the filter stack, with the syringe plunger being used to force the slurry out of the syringe barrel and through the filter stack. The slurry could also be dispensed from a container containing an agitator to prevent the dispersion of inorganic particles from settling out of the dispersion before being passed through the filter stack. In addition, a peristaltic pump could be used to force the slurry through the filter stack in lieu of pressurized air or gas.

The embedded filter can be used to remove impurities, such as ionic species, from compositions by forcing the compositions through the embedded filter, either in a single pass, or by using a recirculating method. For recirculation, the filtered composition is again passed through the embedded filter at least about 2 times (i.e., for a total of 3 times), and more preferably from about 5 times to about 25 times. The embedded filter can also be used in-line as a continuous filtering device for a desired circulation time. Although the concentration will vary, compositions to be filtered according to the invention generally have an initial ionic impurity concentration of from about 50 ppb to about 5,000 ppb, and more preferably from about 100 ppb to about 500 ppb. Impurities that can be removed using the embedded filter include ions of sodium, potassium, calcium, magnesium, iron, chromium, nickel, aluminum, manganese, cobalt, copper, zirconium, tin, lithium, zinc, and mixtures thereof.

Any solvent-based material is suitable for filtration according to the invention. It will be appreciated that pressure and pore size of the embedded filter can be adjusted depending upon the viscosity of the composition to be filtered. However, preferred compositions will have a Brookfield viscosity ranging from about 1 cP to about 500 cP, and preferably from about 5 cP to about 300 cP at about room temperature (˜25° C.). Preferred compositions will comprise a solvent system or monomers, oligomers, and/or polymers dispersed or dissolved in a solvent system. Suitable solvent systems include a solvent selected from the group consisting of PGME, PGMEA, ethyl lactate, propylene glycol n-propyl ether (PnP), cyclohexanone, gamma-butyrolactone, and mixtures thereof. Suitable monomers, oligomers, and polymers, are selected from the group consisting of poly(amic acid), acrylates, free radical reaction products, polymides, step growth polymerization products, condensation reaction products, combinations thereof, and derivatives thereof. Exemplary compositions that can be filtered using the invention include those selected from the group consisting of anti-reflective compositions, photoresists, protective coatings, gap fill polymers, and precursor or intermediate compositions thereof.

Regardless of the embodiment, the composition to be filtered is added to a container that is connected to the inlet side of the embedded filter, directly, or via a hose, tube, pipe, or similar connector (not shown). The outlet side of the embedded filter can be connected to a collection tank directly, or via a hose, tube, pipe, or similar connector. Alternatively, the outlet side of the embedded filter can be reconnected back to the container for recirculation of the composition being filtered. The composition is then passed through the embedded filter until the desired level of ion removal is obtained. The rate of filtration is preferably from about 10 g/min. to about 2,000 g/min., and more preferably from about 50 g/min. to about 1,000 g/min.

The embedded filter preferably removes at least about 80% of the ions from the composition, and more preferably from about 85% to about 95% of the ions from the composition, based upon the total ion concentration in the composition before filtering taken as 100%. In particular, the ion concentration in the filtered composition is preferably less than about 5 ppb, and more preferably less than about 1 ppb.

It will be appreciated that some ions may be introduced into the filtered composition from the inorganic particles, and will vary depending upon the filtered composition and the choice of inorganic particles, and its co-existing elements. The level of “contamination” from the inorganic particles will preferably be less than about 100 ppb, more preferably less than about 30 ppb, and even more preferably less than about 10 ppb. Traditional anion exchange resin filtering, as described in Example 6, can be used to easily remove any contaminants and reduce the level of contamination to less than about 10 ppb, and more preferably less than about 1 ppb.

Regardless of the embodiment, the resulting compositions, when applied to a substrate, will have fewer defects than unfiltered compositions. For example, the filtered composition can be applied to a substrate, preferably by spin-coating, to form a layer of the composition on the substrate. The layer is then baked to remove the solvent. Compositions filtered according to the invention will preferably have less than about 200 defects per wafer, and more preferably less than about 100 defects per wafer, as compared to defects obtained using an unfiltered composition.

### EXAMPLES

The following examples set forth preferred methods in accordance with the invention. It is to be understood, however, that these examples are provided by way of illustration and nothing therein should be taken as a limitation upon the overall scope of the invention.

### Example 1

### Solvent Ion Exchange

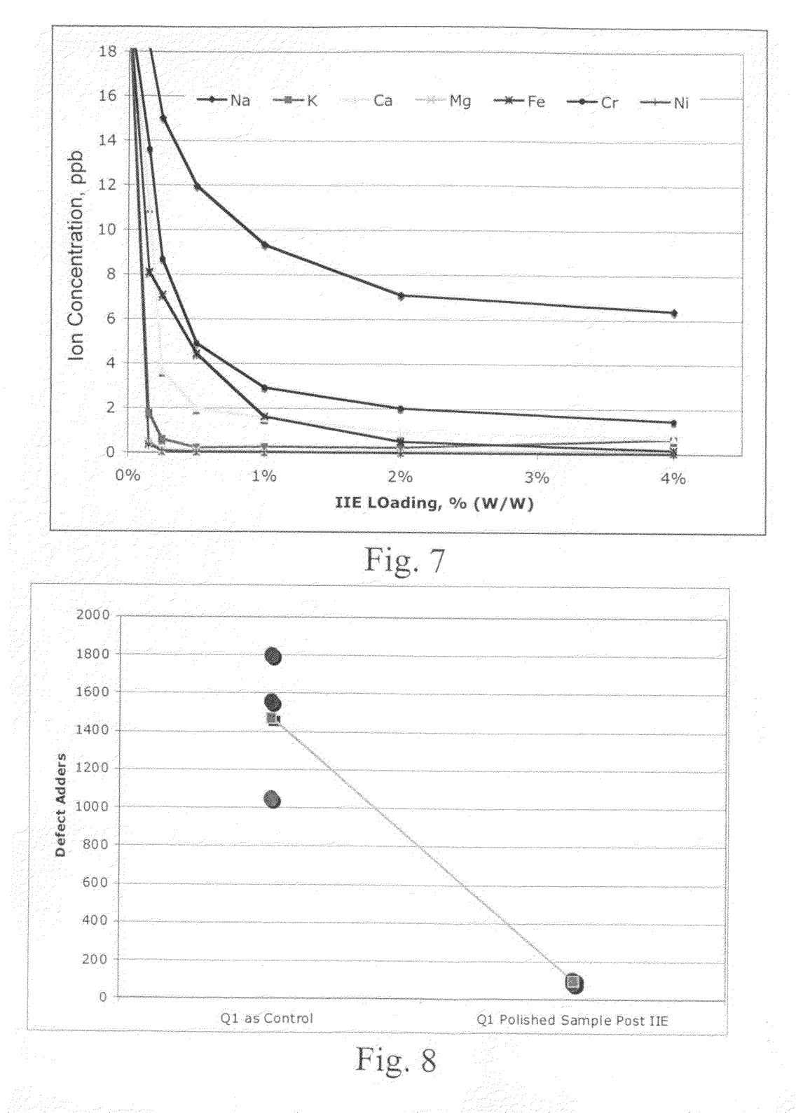

Propylene glycol monomethyl ether (PGME) (UltraPure LLC, Darien, Conn.) was used as the testing medium (solvent). In this procedure, 20 ppb of various cations from a reference solution (Plasma-Pure Standard Solution, Teledyne Leeman Labs, Hudson, N.H.) were mixed into the PGME, then sampled and tested for ions using a Perkin-Elmer ELAN DRCII mass spectrometry (ICM-MS; Waltham, Mass.). To prepare the various embedded filters, various loading ratios (solid acid/solvent wt/wt) of Tungstic acid (Sigma-Aldrich, St. Louis, Mo.) were prepared and mixed for 60 minutes before filtering through 0.1 μm end-point filter disks (Whatman, Sanford, Me.). The prepared reference solutions were then filtered using the embedded filter, and the ions were analyzed. Ions were reduced substantially, as seen in FIG. 7.

### Example 2

### In-Process Product Ion Exchange

A filter system was prepared in the following order: an EFD® Optimum® cartridge, retainer, and cap (EFD, Inc., Atlanta, Ga.); a Meissner Vangard® 5.0-μm capsule upper filter (Meissner Filtration Products, Inc., Camarillo, Calif.); and a Mykrolis Optimizer D PR, 0.1-μm medium capsule lower filter (Entegris, Inc., Billerica, Mass.). Next, 40 grams of BurnEX™ Plus A1590 antimony pentoxide (10-40 μm agglomerates of 0.06 μm particles, Nyacol Technologies, Inc., Ashland, Mass.) were weighed into a 1-liter Aicello bottle (Aicello Chemical Co., Ltd., Toyohashi, Aichi, Japan). PGME (UltraPure LLC, Dariem, Conn.), in the amount of 850 grams, was then added. The bottle was sealed and hand shaken for 1 minute to form a dispersed slurry. The slurry was poured into the EFD® cartridge until full, the cap was immediately replaced, and the slurry was filtered with 5±2 psig nitrogen gas through the filter stack to waste. The slurry bottle was shaken, and the cartridge was refilled as needed until all the slurry was filtered. The upper filter was then removed from the stack, and the stack was reassembled, to include only the lower filter. Next, 850 grams of PGME were added to the EFD® cartridge, and 5±2 psig nitrogen gas was applied to flush the embedded filter to waste. This 850-gram PGME flushing was repeated two times. The filter was then removed, capped, and bagged until use.

Next, 4,016 grams ARC® DS-K101-304 concentrate (an anti-reflective composition, Brewer Science, Inc., Rolla, Mo.) were placed into a 4-gallon high-density polyethylene (HDPE) cylindrical container (Prolon, Inc., Port Gibson, Miss.) equipped with a lid having inlet and outlet ports and a hole for the agitator shaft. This mixing container was connected to a Yamada double-diaphragm pump (Yamada America, Inc., Arlington Heights, Ill.) using perfluoroalkoxy resin (PFA) tubing and Flaretek® connectors (Entegris, Inc., Billerica, Mass.). The pump outlet was connected, through a Teflon® needle valve, to the inlet side of the embedded filter using PFA tubing with Flaretek® fittings. The outlet side of the embedded filter was connected to the mixing container return line. A Teflon®-coated stainless steel shaft and impeller (Indco, New Albany, Ind.) were assembled and connected to an air-driven agitator (Arrow Engineering Co., Inc., Hillside, N.J.) such that the impeller was near the bottom of the mixing container, and the shaft was vertical. The speed was set to 249 rpm. The pump was started at a flow rate of 80±10 g/min., and the material was recirculated for 3.5 hours. A sample was then obtained from the container for ion analysis, which showed that 95% of the ions were removed by the embedded filter from the anti-reflective composition with this process (31.3 nano-equivalents/mL was reduced to 1.6 nano-equivalents/mL).

### Example 3

### High-Viscosity Product Ion Exchange

A filter system was prepared in the following order: an EFD® Optimum® cartridge, retainer, and cap (EFD®, Inc., Atlanta, Ga.); a Meissner Vangard® 5.0-μm capsule upper filter (Meissner Filtration Products, Inc., Camarillo, Calif.); and a Sartorius Sartofluor 0.2-μm large capsule lower filter (Sartorius Stedim Biotech, Aubagne, France). BurnEX™ Plus A1590 antimony pentoxide (Nyacol Technologies, Inc, Ashland, Mass.), in the amount of 90 grams, was weighed into a 1-liter Aicello bottle (Aicello Chemical Co., Ltd., Toyohashi, Aichi, Japan). PGMEA (UltraPure Dariem, Conn.), in the amount of 852 grams, was then added. The bottle was sealed and hand shaken for 1 minute to form a dispersed slurry. The slurry was poured into the EFD® cartridge until full, the cap was immediately replaced, and the slurry was filtered with 5±2 psig nitrogen gas through the filter stack to waste. The slurry bottle was shaken, and the cartridge was refilled as needed until all of the slurry was filtered. The upper filter was then removed from the stack, and the stack was reassembled, to include only the lower filter. PGME, in the amount of 850 grams, was then added to the EFD® cartridge, and 5±2 psig nitrogen gas was applied to the filter to flush the embedded filter to waste. This 850-gram PGME flushing was repeated two more times. The embedded filter was then removed, capped, and bagged until use.

A filter stack was assembled, with the stack including a Sartopure PP2 1.2-μm capsule filter (Sartorius Stedim Biotech, Aubagne, France) upstream from the antimony pentoxide-embedded Sartorius Sartofluor 0.2-μm large capsule filter. Next, 8,730 grams of ProTEK PSB-23 material (a protective composition, Brewer Science, Inc., Rolla, Mo.), having a viscosity of 166 cP, were placed into a 4-gallon HDPE cylindrical container (Proton, Inc., Port Gibson, Miss.) equipped with a lid having inlet and outlet ports and a hole for the agitator shaft. This mixing container was connected to a Yamada double-diaphragm pump (Yamada America, Inc., Arlington Heights, Ill.) using PFA tubing and Flaretek® connectors (Entegris, Inc., Billerica, Mass.). The pump outlet was connected, through a Teflon® needle valve, to the inlet side of the filter stack using PFA tubing with Flaretek® fittings. The outlet side of the embedded filter was connected to the mixing container return line, A Teflon®-coated stainless steel shaft and impeller (Indco, New Albany, Ind.) connected to an air driven agitator (Arrow Engineering Co., Inc, Hillside, N.J.) were assembled such that the impeller was near the bottom of the mixing container, and the shaft was vertical. The speed was set to 272 rpm. The pump was started at a flow rate of 100±10 g/min., and the first 100±20 grams of material were discarded through the return line. The material was recirculated at 100±10 g/min. for 4.5 hours. A sample was then obtained from the container for ion analysis, and the remaining portion was bottled. Ion analysis showed that 91% of the ions were removed by the embedded filter from the protective composition with this process (43.6 nano-equivalents/mL was reduced to 4.1 nano-equivalents/mL).

### Example 4

### Product Ion Exchange

A filter system was prepared in the following order: an EFD® Optimum® cartridge, retainer, and cap (EFD® Inc, Atlanta, Ga.) and a Mykrolis Optimizer D PR 0.02-μm medium capsule filter (Entegris, Inc., Billerica, Mass.). BurnEX™ Plus A1590 antimony pentoxide (Nyacol Technologies, Inc., Ashland, Mass.), in the amount of 30 grams, was weighed into a 1-liter Aicello bottle (Aicello Chemical Co., Ltd., Toyohashi, Aichi, Japan). PGME (UltraPure LLC, Dariem, Conn.), in the amount of 717 grams, was then added. The bottle was sealed and mixed for 11 minutes to form a dispersed slurry. This slurry was poured into an HDPE container and allowed to settle for 10 minutes. The supernatant was then decanted into another HDPE container to avoid the introduction of the sediment. This supernatant was poured into the EFD® cartridge until full, the cap was immediately replaced, and the supernatant was filtered at 20±2 psig through the filter to waste. The cartridge was refilled as needed until all the supernatant had been filtered. PGME, in the amount of 750 grams, was then added to the EFD® cartridge and 20±2 psig nitrogen gas was applied to flush the embedded filter to waste. This 750-gram PGME flushing was repeated two more times. The embedded filter was then removed, capped, and bagged until use.

Next, 7,455 grams of ARC® DS-K101-304 (an anti-reflective composition, Brewer Science, Inc., Rolla, Mo.) were placed into a 4-gallon HDPE cylindrical container (Prolon, Inc., Port Gibson, Miss.) equipped with a lid having inlet and outlet ports and a hole for the agitator shaft. The mixing container was connected to a Yamada double-diaphragm pump (Yamada America, Inc., Arlington Heights, Ill.) using PFA tubing and Flaretek® connectors (Entegris, Inc., Billerica, Mass.). The pump outlet was connected, through a Teflon® needle valve, to the inlet side of the embedded filter using PFA tubing with Flaretek® fittings. The outlet side of the embedded filter was connected to the mixing container return line. A Teflon® coated stainless steel shaft and impeller (Indco, New Albany, Ind.) were connected to an air-driven agitator (Arrow Engineering Co., Inc., Hillside, N.J.) such that the impeller was near the bottom of the container, and the shaft was vertical. The agitator speed was set to 240 rpm, the pump was started at a flow rate of 739±10 g/min., and the product was recirculated for 4.3 hours. A sample from the container was then obtained for ion analysis, and the remaining sample was bottled. The analysis showed that 50% of the ions were removed by the embedded filter from the anti-reflective composition using this process (0.4 nano-equivalents/mL was reduced to 0.2 nano-equivalents/mL).

A filtered material prepared as above was also analyzed for coating defects by spin-coating the sample onto a silicon wafer and baking the coated wafer. The coating defects were measured on a CS-20 Candela (KA Tenor) using dark-field scattering. Defects were detected by measuring scattered light. The defects from the pre-coated (bare) wafers were subtracted from the defects on post-coated wafers counted as adders to obtain the net defect reading. The on-wafer defects were reduced using this procedure as shown in FIG. 8.

### Example 5

### Coating Defect Reduction in Polymeric Blend System

In this Example, DUV42P-312 (an anti-reflective composition, Brewer Science, Inc., Rolla, Mo.), having a solvent composition of 70% PGME and 30% PGMEA, an acrylate polymer blend composed of 4.1% solids, and a viscosity of 2.2 cP, was used to assess the contamination and control of particulates. First, 70 grams of BurnEX™ Plus A1590 antimony pentoxide (Nyacol Technologies, Inc., Ashland, Mass.) were weighed into 7.8 kg of the anti-reflective product. The mixture was then agitated and pumped through a Meissner Vangard® 5.0-nm capsule filter (Meissner Filtration Products, Inc., Camarillo, Calif.) to remove a majority of the solids.

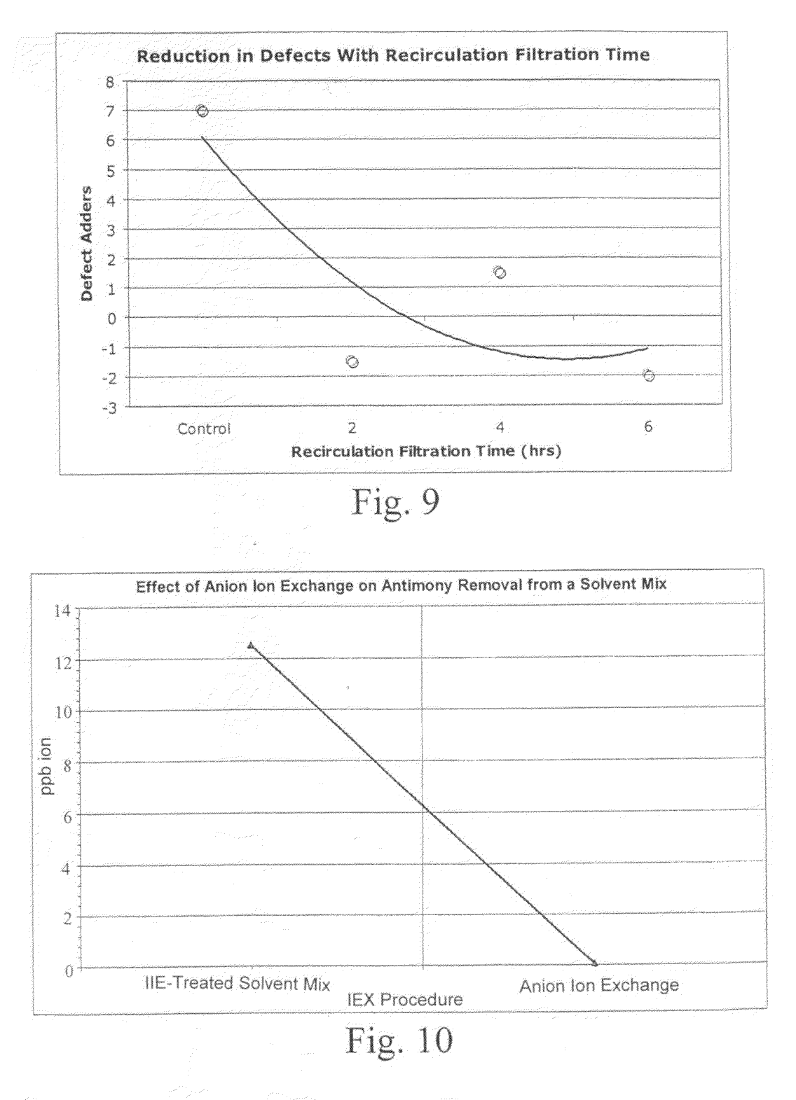

The resulting liquid portion was further filtered through a Mykrolis Optimizer D PR 0.02-μm medium capsule filter (Entegris, Inc., Billerica, Mass.) in a recirculation mode at 0.7 L/min. Samples were taken at 2-hour intervals for six hours, and then tested by applying to silicon wafers, baking, and analyzing the defect counts. A Tel. Mark eight coating track was used to coat and bake the wafers at 205° C. for 60 seconds. The coating defects were measured on a CS-20 Candela (KA Tenor) using dark-field scattering. Defects were detected by measuring scattered light. The defects from the pre-coated wafers were subtracted from the post-coated wafers to obtain the net defect count from the coating. The unfiltered original DUV42P-312 was used as the control. Defect counts with this treatment were decreased compared to the control (see FIG. 9).

### Example 6

### Solvent Blend

A filter system was prepared in the following order: an EFD® Optimum® cartridge, retainer, and cap; a Meissner Vangard® 5.0-nm capsule upper filter; and a Mykrolis Optimizer D PR 0.1-μm medium capsule lower filter (Entegris, Inc., Billerica, Mass.). BurnEX™ Plus A1590 antimony pentoxide (Nyacol Technologies, Inc., Ashland, Mass.), in the amount of 40 grams, was weighed into a 1-liter Aicello bottle (Aicello Chemical Co., Ltd., Toyohashi, Aichi, Japan). PGME (UltraPure LLC, Darien, Conn.), in the amount of 850 grams, was then added. The bottle was sealed and hand-shaken for 1 minute to form a dispersed slurry. The slurry was poured into the EFD® cartridge until full, the cap was immediately replaced, and the slurry was filtered with 5±2 psig nitrogen gas through the filter stack to waste. The slurry bottle was shaken, and the cartridge was refilled as needed until all of the slurry was filtered. The upper filter was then removed from the stack, and the stack was reassembled, to include only the lower filter. Next, 850 grams of PGME were added to the EFD® cartridge, and 5±2 psig nitrogen gas was applied to the filter to flush the embedded filter to waste. This 850-gram PGME flushing was repeated two more times. The embedded filter was then removed, capped, and bagged until use.

A solvent mix was prepared using the following: 12.9 kg PGME (UltraPure LLC, Darien, Conn.), 17.8 kg PGMEA (UltraPure LLC, Darien, Conn.), and 1.3 kg cyclohexanone (flarcros Chemicals, Inc., Kansas City, Kans.). These solvents were weighed into a 10-gallon LDPE container (Saint-Gobain Performance Plastics, Mickleton, N.J.) equipped with a lid having inlet and outlet ports and a hole for the agitator shaft. The solvents were mixed for 37 minutes at 400 rpm using a Teflon®-coated stainless steel shaft and impeller (Indco, New Albany, Ind.) connected to an air-driven agitator (Arrow Engineering Co., Inc., Hillside, N.J.) such that the impeller was near the bottom of the mixing container, and the shaft was vertical.

The mixing container was connected to a Yamada double-diaphragm pump (Yamada America, Inc., Arlington Heights, Ill.) using perfluoroalkoxy resin (PFA) tubing and Flaretek® connectors (Entegris, Inc., Billerica, Mass.). The pump outlet was connected, through a Teflon® needle valve, to the inlet side of the embedded filter using PFA tubing with Flaretek® fittings. The outlet side o r the embedded filter was connected to the mixing container return line. The pump was started at a flow rate of 1.8 kg/min., and the material was recirculated for 1.5 hours. A sample was then obtained from the container for ion analysis, which showed that 70% of the ions were removed by the embedded filter from the solvent mixture with this process (0.11 nano-equivalents/mL was reduced to 0.03 nano-equivalents/mL).

The filtered sample was found to contain 13 ppb antimony as a process contamination. It was desirable to remove this by using a traditional powdered anion exchange resin PrAOH (The Purolite Company, Bala Cynwyd, Pa.). An embedded filter was prepared as above, using only the lower filter. A filter stack was prepared in the following order: an EFD® Optimum® cartridge, retainer, and cap; and a Mykrolis Optimizer D PR 0.1-μm medium capsule filter (Entegris, Inc., Billerica, Mass.). PrAOH in the amount of 20 grams was weighed into a 1-liter Aicello bottle (Aicello Chemical Co., Ltd., Toyohashi, Aichi, Japan). PGME (UltraPure LLP, Darien Conn.), in the amount of 904 grams, was then added. The bottle was sealed and hand shaken for 1 minute to form a dispersed slurry. The slurry was poured into the EFD® cartridge until full, the cap was immediately replaced, and the slurry was filtered with 8-15 psi nitrogen gas through the filter stack to waste. The slurry bottle was shaken and the cartridge was refilled until all of the slurry was filtered. To flush the embedded filter, 1 liter of PGME was added to the EFD® cartridge, and 20 psi of nitrogen gas was applied until all of the PGME was flushed to waste.

Next, 280 grams of the filtered solvent mix prepared above was passed through the PrAOH-embedded filter at 8 psi through the EFD® tube. There was no detectable antimony in the resulting sample, as shown in FIG. 10.

We claim:

1. A method of removing ionic impurities from a solvent-based composition, said method comprising passing said composition through an embedded filter to yield a filtered composition, said filter comprising filtration media embedded with inorganic particles.

2. The method of claim 1, wherein said inorganic particles are selected from the group consisting of metal oxides, metal salts, and combinations thereof.

3. The method of claim 2, wherein said metal oxides and metal salts are selected from the group consisting of oxides and salts of antimony, tungsten, molybdenum, and combinations thereof.

4. The method of claim 1, wherein said filtration media comprises fibers and microfibers selected from the group consisting of high-density polypropylene, ultra-high molecular weight polypropylene, polytetrafluoroethylene, nylon, and combinations thereof.

5. The method of claim 1, wherein said composition is brought into contact with said inorganic particles to thereby remove said impurities.

6. The method of claim 1, wherein said composition comprises a solvent system, said solvent system comprising a solvent selected from the group consisting of propylene glycol monomethyl ether, propylene glycol methyl ether acetate, ethyl lactate, propylene glycol n-propyl ether, cyclohexanone, gamma-butyrolactone, alcohols, aqueous mixtures, ethers, lactones, cyclohexanone, and mixtures thereof.

7. The method of claim 1, wherein said composition is selected from the group consisting of photoresist compositions, anti-reflective compositions, protective coatings, gap fill polymers, and precursor and intermediate compositions thereof.

8. The method of claim 1, wherein said composition is passed through said filter at a rate of from about 10 g/min. to about 2,000 g/min.

9. The method of claim 1, said composition having an initial concentration of impurities, wherein said initial concentration is decreased by at least about 80% after said passing.

10. The method of claim 1, wherein said filtered composition comprises an ionic impurity concentration of less than about 5 ppb.

11. The method of claim 1, further comprising recirculating said filtered composition through said embedded filter.

12. The method of claim 11, wherein said recirculating comprises passing said filtered composition through said embedded filter at least about 2 times.

13. The method of claim 1, wherein said impurities are selected from the group consisting of ions of sodium, potassium, calcium, magnesium, iron, chromium, nickel, aluminum, manganese, cobalt, copper, zirconium, tin, lithium, zinc, and mixtures thereof.

14. The method of claim 1, further comprising passing said filtered composition through a second filter comprising anion exchange resin.

15. An embedded filter for removing impurities from solvent-based compositions, said filter comprising a filtration media embedded with inorganic particles, wherein said particles have an average particle size of from about 0.02 μm to about 50 μm.

16. The embedded filter of claim 15, wherein said inorganic particles are physically immobilized in said media.

17. The embedded filter of claim 15, wherein said inorganic particles are selected from the group consisting of metal oxides, metal salts, and combinations thereof.

18. The embedded filter of claim 17, wherein said metal oxides and metal salts are selected from the group consisting of oxides and salts of antimony, tungsten, molybdenum, and combinations thereof.

19. The embedded filter of claim 15, wherein said inorganic particles are distributed substantially uniformly throughout said filtration media.

20. The embedded filter of claim 15, wherein said filtration media comprises a porous matrix having an average pore size of from about 0.02 μm to about 1 μm.

21. The embedded filter of claim 15, wherein said filtration media comprises fibers and microfibers selected from the group consisting of high-density polypropylene, ultra-high molecular weight polypropylene, polytetrafluoroethylene, nylon, and combinations thereof.

22. The embedded filter of claim 15, wherein a second filter is adjacent said embedded filter.

23. A method of preparing an inorganic particle-embedded filter, said method comprising:
providing a slurry comprising inorganic particles dispersed in a solvent system;
passing said slurry through a filtration media; and
rinsing said filtration media with additional solvent to remove loose inorganic particles to thereby yield said embedded filter.

24. The method of claim 23, wherein said filtration media comprises a filter stack, said stack comprising an optional first filter comprising a first filtration media and a second filter comprising a second filtration media.

25. The method of claim 24, wherein said passing is carried out using a filter system comprising a filter embedding assembly coupled to said filter stack, and an external pressure source coupled to said filter embedding assembly, said filter embedding assembly comprising a cartridge, a retainer configured to receive said cartridge, and a retainer cap, wherein said retainer cap comprises an inlet and said external pressure source is coupled to said cap inlet.

26. The method of claim 25, wherein said cartridge comprises an outlet and a fluid-receiving space, and wherein said providing comprises adding said slurry to said fluid receiving space.

27. The method of claim 26, wherein said passing comprises introducing pressurized air or gas from said external pressure source into said fluid receiving space through said cap inlet, said pressurized air or gas pushing said slurry out said cartridge outlet and through said filter stack.
